(19) United States
(12) Patent Application Publication
(10) Pub. No.: US 2025/0373137 A1
(43) Pub. Date: Dec. 4, 2025

(54) Fluid Stream Driven Wobble Plate Motor for Energy Generation

(71) Applicant: Jerry F. Willis, Houston, TX (US)

(72) Inventor: Jerry F. Willis, Houston, TX (US)

(21) Appl. No.: 19/084,350

(22) Filed: Mar. 19, 2025

Related U.S. Application Data
(60) Provisional application No. 63/652,867, filed on May 29, 2024.

(51) Int. Cl. H02K 41/06

(52) U.S. Cl. CPC H02K 41/065

(57) ABSTRACT

Systems for generating electricity are described. The systems use a wobble plate motor to transform the energy of a fluid into rotation of a shaft, which in turn may be used to drive a generator. Embodiments of the wobble plate motors described herein have a shaft that is hollow and that provides a conduit for the fluid. As the wobble plate motor nutates, the shaft and other components of the fluid delivery assembly turn with the motion of the wobble plate.

### CROSS-REFERENCE TO RELATED APPLICATIONS

This is a non-provisional of U.S. Provisional Patent Application Ser. No. 63/652,867, filed May 29, 2024, which is incorporated herein by reference in its entirety, and to which priority is claimed.

### FIELD OF THE INVENTION

This application relates to a motor driven by a high inertia fluid stream, and more particularly, to systems and methods for using such a motor to generate electricity.

### SUMMARY

Disclosed herein is a system for generating electricity, the system comprising: a wobble plate motor comprising: a disc, and a combined shaft/fluid distribution assembly comprising: a tubular shaft configured to transport fluid, wherein the disc is rotatably mounted to the shaft at a connection point on the shaft, and at least one tubular lateral member configured to direct the fluid to a surface of the disc, thereby causing the disc to nutate. According to some embodiments, the shaft comprises first and second longitudinal sections configured to rotate about a longitudinal axis, and an oblique section configured between the first and second longitudinal section, the oblique section having an oblique axis, wherein the connection point is on the oblique section. According to some embodiments, the wobble plate motor is configured such that, when the disc nutates, the disc nutates about the longitudinal axis. According to some embodiments, the wobble plate motor is configured such that, when the disc nutates, the at least one tubular lateral member revolves around the longitudinal axis. According to some embodiments, the wobble plate motor is configured such that the at least one tubular lateral member revolves around the longitudinal axis contributes centrifugal force to fluid within the at least one tubular lateral member. According to some embodiments, the at least one tubular lateral member comprises a first tubular lateral member configured to direct the fluid to a first surface of the disc and a second tubular lateral member configured to direct the fluid to a second surface of the disc. According to some embodiments, the disc comprises a rotating bevel gear on a first surface of the disc. According to some embodiments, the wobble plate motor comprises a stationary bevel gear configured to mesh with the rotating bevel gear. According to some embodiments, the wobble plate motor is configured within a housing, the housing comprising a top panel, wherein the stationary bevel gear is attached to the top panel. According to some embodiments, the housing comprises a bottom panel, wherein the bottom panel is perforated. According to some embodiments, the system further comprises a tank configured below the housing and configured to hold a fluid. According to some embodiments, the system further comprises a pump configured to be submerged in the fluid and configured to pump fluid into the tubular shaft. According to some embodiments, the system is configured to allow fluid in the housing to drain into the tank via the perforated bottom panel. According to some embodiments, the system further comprises a tank elevated with respect to the wobble plate motor and configured to provide fluid to the tubular shaft under gravity pressure. According to some embodiments, the system further comprises an electric generator configured to convert the rotation of the first longitudinal section into electricity. According to some embodiments, the connection point coincides with the intersection of the longitudinal axis with the oblique axis. Also disclosed herein are methods of operating any of the systems described herein, particularly for making electricity.

### BRIEF DESCRIPTION OF THE DRAWINGS

FIG. 1 shows an embodiment of a wobble plate motor.

FIG. 2 shows an embodiment of a wobble plate motor.

FIG. 3 shows various views of an embodiment of a wobble plate motor.

FIGS. 4A and 4B show two embodiments of a wobble plate motor.

FIG. 5 shows an embodiment of a system for producing electricity using a wobble plate motor.

### DETAILED DESCRIPTION

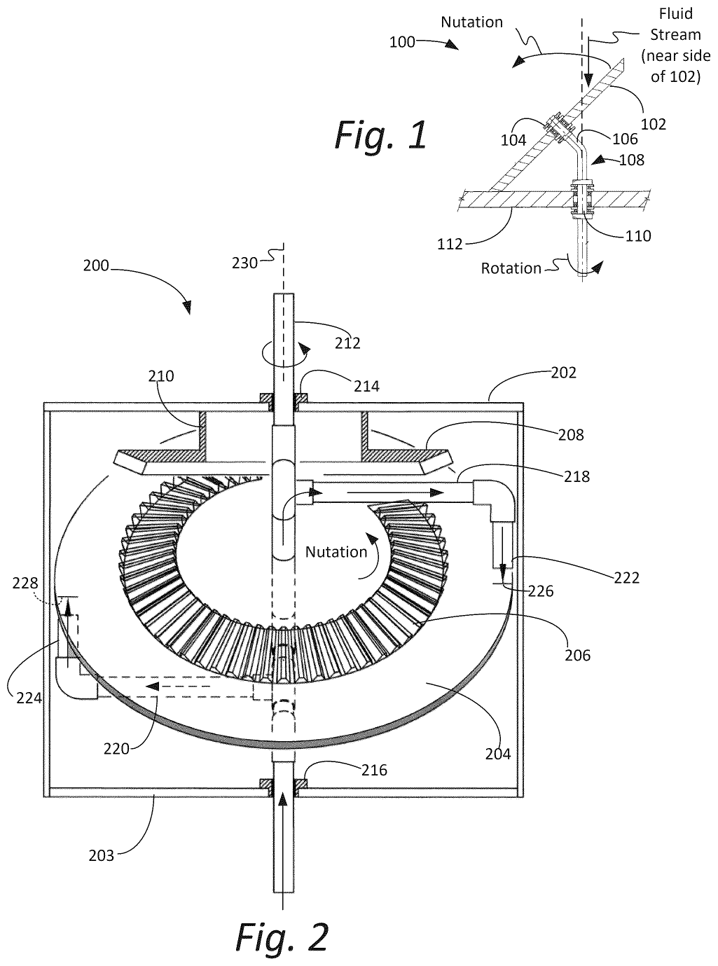

FIG. 1 shows an embodiment of a wobble plate motor mechanism 100, as described in U.S. Pat. No. 9,551,223 (“the '223 Patent), the entire contents of which are hereby incorporated by reference. The motor mechanism comprises an inclined plate or disc 102 journaled or rotatably mounted via a bearing assembly 104 on an angled portion 106 of a shaft 108. The shaft is rotatably mounted by a bearing assembly 110 to a planar base 112. Force applied to a segment of the disc 102, for example, by a stream of fluid as shown in the drawing, causes the disc to roll (i.e., rotate) on the planar base, thereby rotating the shaft in the direction shown. As the shaft rotates, the disc roles around the axis 109 of the shaft. The rotation of the shaft may be used as an input to a work consumer, such as an electrical generator, pump, compressor, or the like. The rotation and rolling of the disc is similar to that of a spinning coin as it begins to decay and rotates inclined to its axis of rotation. This type of motion may be referred to as nutation. As described in the '223 Patent, the disc 102 and the planar base 112 may be configured with meshing gears to guide the rotation.

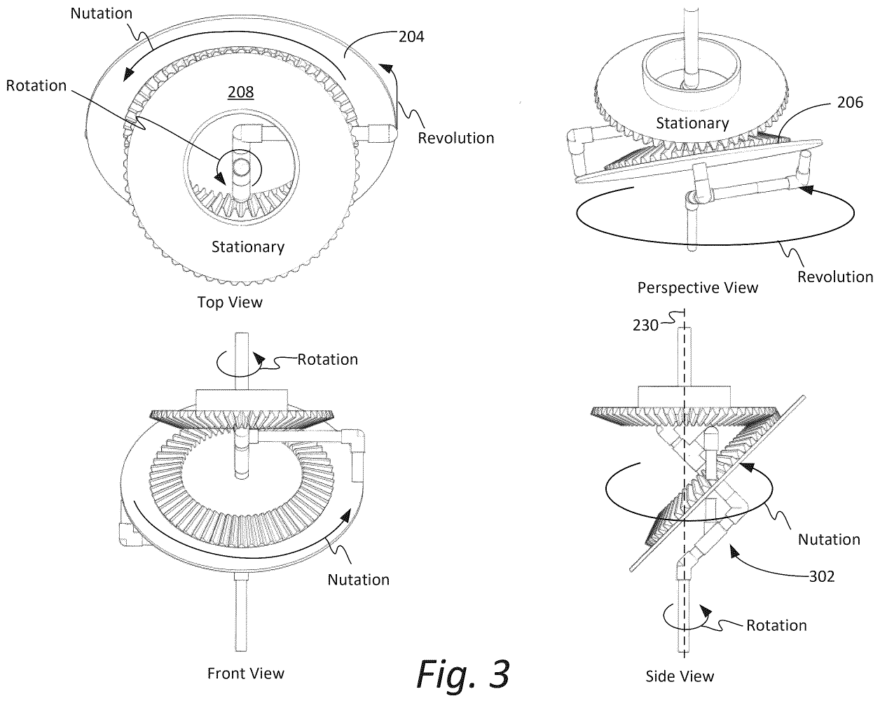

FIG. 2 illustrates another embodiment of a wobble plate motor 200. The illustrated wobble plate motor 200 is contained within an enclosure or housing 202. The bottom panel 203 of the housing may be perforated, for reasons that will become apparent below. The wobble plate motor 200 comprises a disc 204 that is configured with a rotating bevel gear 206. Unlike the wobble plate motor 100 illustrated in FIG. 1, the embodiment of the illustrated wobble plate motor 200 does not have a planar base plate. Instead, it is equipped with a stationary bevel gear 208 (best seen in FIG. 3). The stationary bevel gear 208 may be suspended from a top panel of the housing 202 via a flange 210 or other suspension element. The disc 204 is suspended within the housing and rotatably mounted to a shaft 212. The disc may be attached to the shaft via a bearing assembly, as described above (not shown). The shaft 212 may be suspended within the housing via a top bearing assembly 214 and a bottom bearing assembly 216.

In the illustrated wobble plate motor 200, the shaft 212 is tubular and provides a conduit for the transport of fluid used to turn the disc 204. The shaft may be made of a polymeric material, such as polyvinyl chloride (PVC) or of a metallic material, for example. A top lateral member 218, bottom lateral member 220, top nozzle 222, and bottom nozzle 224 are affixed to the shaft 212 to direct the fluid to impact locations 226 and 228 on the disc 204. Note that the fluid impact location 226 is on the upper surface of the disc and the fluid impact location 228 is on the underside (lower surface) of the disc 204. The combination of the shaft 212, the arms 218 and 220, and the nozzles 22 and 224 may be referred to herein as a combined shaft/fluid distribution assembly. It should be appreciated that other configurations of a shaft/fluid distribution assembly are possible and within the scope of the disclosure. For example, the combined shaft/fluid distribution assembly may comprise two top lateral members and two bottom lateral members, for example, to promote weight distribution. In such an embodiment, one of the top lateral members and one of the bottom lateral members would be plugged off to direct the fluid to the proper impact locations on the disc.

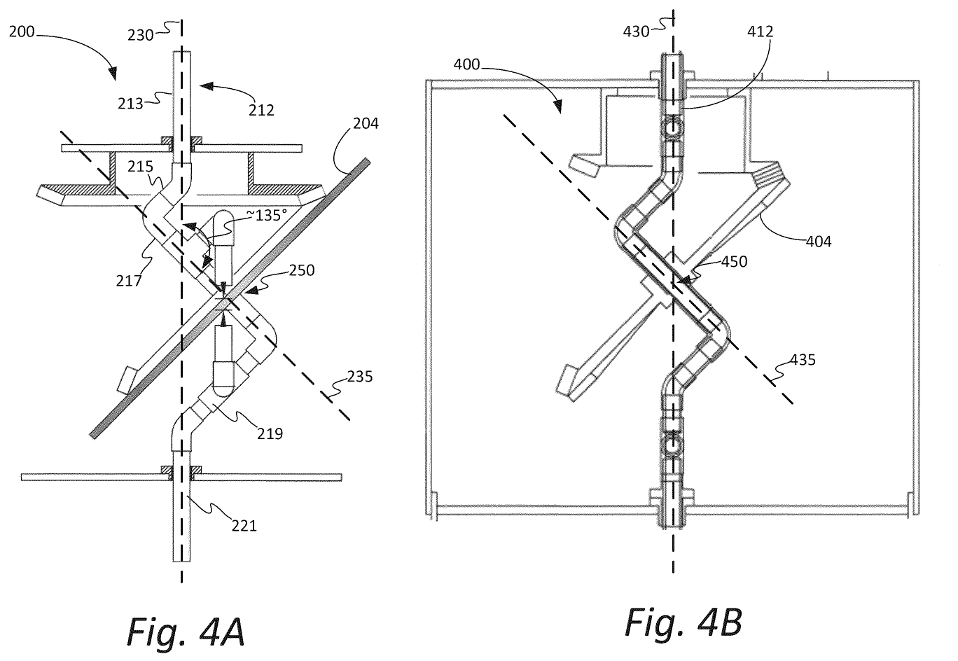

Arrows are shown within the interior of the shaft/fluid distribution assembly in FIG. 2 to illustrate the flow of fluid through the assembly. During operation fluid is typically drawn or pumped from a reservoir or tank located below the housing 202, as described in more detail below. The fluid traverses under pressure through the shaft/fluid distribution assembly as indicated by the arrows and is directed to the impact locations 226 and 228. The energy of the fluid is imparted to the disc causing the disc to nutate. FIG. 3 shows top, perspective, front, and side views of the disc 204, the rotating bevel gear 206, the stationary bevel gear 208, and the shaft/fluid distribution assembly 302 to provide the reader with a clearer understanding of the arrangement of those components. Likewise, FIG. 4A shows a side view of the wobble plate motor 200, with various axes indicated to provide the reader with a clearer understanding of the motion of the various components.

Referring to FIG. 4A, the shaft 212 comprises sections that are arranged longitudinally and a section arranged obliquely. Specifically, the shaft in the embodiment illustrated in FIG. 4A comprises first and second longitudinal sections 213 and 221, respectively. The longitudinal sections are configured to rotate about a longitudinal axis 230. An oblique section 217 is situated between the first and second longitudinal sections. The oblique section has an oblique axis 235. In the illustrated embodiment, the oblique axis 235 intersects the longitudinal axis 230 at about 135 degrees. In the illustrated embodiment, the oblique section is connected to the longitudinal sections via a first angled connection 215 and a second angled connection 219. The angle between the first longitudinal section 213 and the first angled connection 215 is typically about 135 degrees (e.g., about 125-145 degrees). The angle between the first angled connection 215 and the longitudinal section 217 is typically about 90 degrees (e.g., about 80-100 degrees). The angle between the longitudinal section 217 and the second angled connection section 219 is typically angled at about 90 degrees (e.g., about 80-100 degrees). The angle between the second angled connection section 219 and the second longitudinal section 221 is typically about 135 degrees (e.g., about 125-145 degrees). It will be appreciated that these angles may be modified, depending on design considerations.

Still referring to FIG. 4A, the disc 204 is rotatable mounted to the shaft at a point on the oblique section 217 of the shaft. When fluid is delivered to the impact location(s) on the disc 204, the energy imparted by the fluid causes the disc to nutate around the shaft, and specifically to nutate around the oblique axis 235. This nutation is shown in several of the Top View and the Front view illustrated in FIG. 3. The nutation of the disc about the oblique axis causes the disc to nutate about the longitudinal axis 230, as shown in the side view of FIG. 3. The meshing of the rotating and stationary gears (206 and 208, respectively) can guide the motion of the disc, as illustrated in the views of FIG. 3. During the motion of the disc, the lateral member(s) (i.e., 218 and 220, FIG. 2) of the shaft/fluid distribution assembly revolve around the longitudinal axis 230, as shown in the Perspective View of FIG. 3. As the shaft/fluid distribution assembly revolves, centrifugal motion may add energy to the fluid in the assembly, thereby imparting more energy into the disc. The motion of the wobble plate components also results in rotation of the longitudinal portions of the shaft (i.e., 213 and 221, FIG. 4) about the longitudinal axis 230, which is the movement that can be harnessed by a work consumer, such as a generator for the generation of electricity.

FIG. 4B shows a side view of an alternative embodiment of a wobble plate motor 400, which may be compared to the wobble plate motor 200 shown in FIG. 4A. Note that in the drawing of the wobble plate motor 400, the top and bottom lateral members and the top and bottom nozzles are omitted for clarity. Referring to FIG. 4A, notice that the point 250 where the disc is rotatably connected to the longitudinal section of the shaft is off set from the longitudinal axis 230. But in the wobble plate motor 400 (FIG. 4B), the connection point 450 lies upon the longitudinal axis 430. In other words, in the wobble plate motor 400, the connection point is at the same point that the longitudinal axis and the oblique axis intersect. In some embodiments, this in line geometry can add balance to the system. It will be appreciated that the shaft 412 of the wobble plate motor 400 generally comprises similar vertical and angled sections, as described above, though those sections are not explicitly denoted in the drawing.

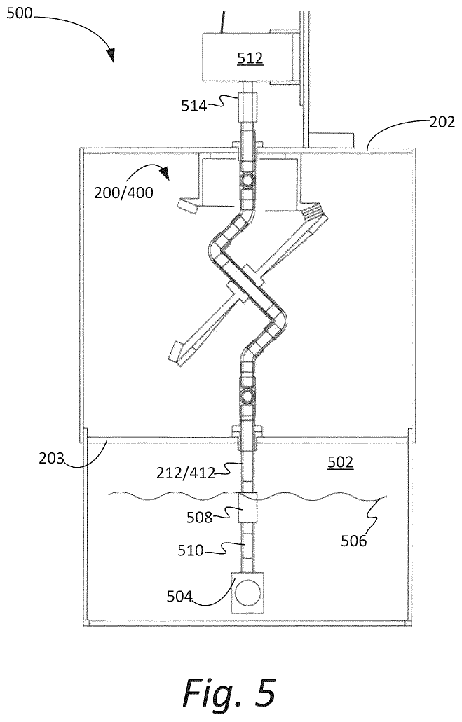

FIG. 5 illustrates an embodiment of a system 500 for generating electricity using a wobble plate motor 200/400. The components and operation of the wobble plate motor 200/400 are described above and will not be repeated here, other than to mention that the wobble plate motor is configured within a housing 202. Note that in FIG. 5, the top and bottom lateral members and the top and bottom nozzles are omitted for clarity. As mentioned above, the bottom panel of the housing 203 is perforated. The housing 202 may be situated on top of a fluid tank 502 that is configured to contain a fluid, such as water. A pump 504 is submerged below the surface 506 of the fluid. The shaft 212/412 of the wobble plate motor is coupled to the pump 504 via a coupling 508 connecting the shaft to a conduit 510 attached to the pump. The coupling 508 may allow the shaft to spin and the conduit 510 to remain stationary. The coupling 508 may be a labyrinth seal, for example. The pump may be configured to pump fluid from the tank through the shaft/fluid distribution assembly, whereby the fluid is directed to the disc, causing the disc and the shaft/fluid distribution assembly to move, as described above. The fluid may then drain back into the tank 502 via the perforations in the base of the housing 203. The upper part of the shaft 212/412 may be coupled to a generator 512 via a coupling 514. The generator may be configured to convert the rotational motion of the shaft into electrical energy, as is known in the art. For example, the rotational motion of the shaft may turn a rotor of the generator to induce a voltage difference in windings of a stator of the generator. Because of the mechanical advantages afforded by the wobble motor, the power produced by the generator 512 exceeds the power consumed by the pump 504.

Other embodiments of systems for generating electricity from the wobble plate motor may be contemplated. For example, according to some embodiments, the fluid may be supplied from an elevated tower or reservoir. In such embodiments, the pressure of the fluid may be supplied by gravity, thereby reducing, or obviating the need for the pump 504. In other embodiments, the tank 502 may be pressurized.

Although particular embodiments of the present invention have been shown and described, it should be understood that the above discussion is not intended to limit the present invention to these embodiments. It will be obvious to those skilled in the art that various changes and modifications may be made without departing from the spirit and scope of the present invention. Thus, the present invention is intended to cover alternatives, modifications, and equivalents that may fall within the spirit and scope of the present invention as defined by the claims.

What is claimed is:

1. A system for generating electricity, the system comprising:
a wobble plate motor comprising:
a disc, and a combined shaft/fluid distribution assembly comprising:
a tubular shaft configured to transport fluid, wherein the disc is rotatably mounted to the shaft at a connection point on the shaft, and
at least one tubular lateral member configured to direct the fluid to a surface of the disc, thereby causing the disc to nutate.

2. The system of claim 1, wherein the shaft comprises first and second longitudinal sections configured to rotate about a longitudinal axis, and an oblique section configured between the first and second longitudinal section, the oblique section having an oblique axis, wherein the connection point is on the oblique section.

3. The system of claim 2, wherein the wobble plate motor is configured such that, when the disc nutates, the disc nutates about the longitudinal axis.

4. The system of claim 2, wherein the wobble plate motor is configured such that, when the disc nutates, the at least one tubular lateral member revolves around the longitudinal axis.

5. The system of claim 4, wherein the wobble plate motor is configured such that the at least one tubular lateral member revolves around the longitudinal axis contributes centrifugal force to fluid within the at least one tubular lateral member.

6. The system of claim 2, wherein the at least one tubular lateral member comprises a first tubular lateral member configured to direct the fluid to a first surface of the disc and a second tubular lateral member configured to direct the fluid to a second surface of the disc.

7. The system of claim 2, wherein the disc comprises a rotating bevel gear on a first surface of the disc.

8. The system of claim 7, wherein the wobble plate motor comprises a stationary bevel gear configured to mesh with the rotating bevel gear.

9. The system of claim 8, wherein the wobble plate motor is configured within a housing, the housing comprising a top panel, wherein the stationary bevel gear is attached to the top panel.

10. The system of claim 9, wherein the housing comprises a bottom panel, wherein the bottom panel is perforated.

11. The system of claim 10, further comprising a tank configured below the housing and configured to hold a fluid.

12. The system of claim 11, further comprising a pump configured to be submerged in the fluid and configured to pump fluid into the tubular shaft.

13. The system of claim 12, wherein the system is configured to allow fluid in the housing to drain into the tank via the perforated bottom panel.

14. The system of claim 2, further comprising a tank elevated with respect to the wobble plate motor and configured to provide fluid to the tubular shaft under gravity pressure.

15. The system of claim 2, further comprising an electric generator configured to convert the rotation of the first longitudinal section into electricity.

16. The system of claim 2, wherein the connection point coincides with the intersection of the longitudinal axis with the oblique axis.

17. A system for generating electricity, as described herein.
